(19) United States
(12) Patent Application Publication
(10) Pub. No.: US 2011/0149098 A1
(43) Pub. Date: Jun. 23, 2011

(54) IMAGE PROCESSING APPARUTUS AND METHOD FOR VIRTUAL IMPLEMENTATION OF OPTICAL PROPERTIES OF LENS

(75) Inventors: Hyun Sang Ahn, Seoul (KR); Myung Ha Kim, Yongin-si (KR); Il Kwon Jeong, Daejeon (KR); Byoung Tae Choi, Daejeon (KR)

(73) Assignee: Electronics and Telecommunications Research Institute, Daejeon (KR)

(21) Appl. No.: 12/857,328

(22) Filed: Aug. 16, 2010

(30) Foreign Application Priority Data
Dec. 18, 2009 (KR) 10-2009-0127354
Mar. 3, 2010 (KR) 10-2010-0019064

(51) Int. Cl. H04N 5/228

(52) U.S. Cl. 348/222.1; 348/E05.031

(57) ABSTRACT

Provided is an image processing apparatus and method that may virtually implement characteristics of an actual lens. The image processing apparatus includes a first image obtaining unit that obtains a raw image through an image capturing apparatus, a foreground/background separation unit that separates a foreground and a background from the raw image obtained by the first image obtaining unit, a lens selecting unit that selects a lens model, a lens characteristic, or a combination thereof the image capturing apparatus, an image processing unit that performs image processing on the foreground and the background by respectively applying a predetermined calibration value for the lens model, the lens characteristic, or the combination thereof, and a second image obtaining unit that synthesizes the image-processed foreground and background to obtain a processed image.

### CROSS-REFERENCE TO RELATED APPLICATIONS

This application claims priority under 35 U.S.C. §119 to Korean Patent Application No. 10-2009-0127354, filed on Dec. 18, 2009, and No. 10-2010-0019064, filed on Mar. 3, 2010, in the Korean Intellectual Property Office, the disclosure of which is incorporated herein by reference in its entirety.

### BACKGROUND OF THE INVENTION

1. Field of the Invention

The present invention relates to an image processing apparatus and method that may virtually implement characteristics of an actual lens in an imaging system such as a digital camera, a camcorder, or a camera phone using a lens system, or in a rendering system using a computer graphics technology.

2. Description of the Related Art

A known imaging apparatus, such as a digital camera, a digital camcorder, or a camera phone, captures an image by digitally recording the strength of electric signal to an image sensor, such as a CCD (“Charge Coupled Device”) or a CMOS (“Complementary Metal Oxide Semiconductor”), and thereby provides various functions that were not achievable in an conventional analog imaging system using a film.

Recently, a growing demand for private web sites, blogs, and UCCs (“User Created Contents”) has increased the need for high-end, high-quality digital contents.

DSLR (“Digital Single Lens Reflex”) cameras and DSLR camcorders allow users to choose from interchangeable lenses having different optical characteristics and thus satisfy users' various needs.

However, other imaging apparatuses, such as digital cameras, digital camcorders, and camera phones, being used by most of common users, don't allow users to change lenses. So, it has a limitation in representing a subject in various ways. Even though some of the imaging devices have interchangeable lenses, they are not completely compatible with other lenses from other manufacturer. Further, lenses for the imaging apparatuses are expensive. Thus, not every user can afford to purchase the lens.

To solve this problem, there was an attempt to virtually implement optical characteristics of an actual lens in a rendering scheme using computer graphics to realistically represent an object.

### SUMMARY OF THE INVENTION

According to an aspect of embodiment of the present invention, there is provided an image processing apparatus including: a first image obtaining unit that obtains a raw image through an image capturing apparatus; a foreground/background separation unit that separates a foreground and a background from the raw image obtained by the first image obtaining unit; a lens selecting unit that selects a lens model, a lens characteristic, or a combination thereof of the image capturing apparatus; an image processing unit that performs image processing on the foreground and the background by respectively applying a predetermined calibration value for the lens model, the lens characteristic, or the combination thereof; and a second image obtaining unit that synthesizes the image-processed foreground and background to obtain a final image.

According to another aspect of the present invention, there is provided an image processing method for virtually representing an image varying with lens characteristics through an image processing scheme, including: analyzing a raw image captured by an image capturing apparatus to separate a foreground and a background from the raw image; selecting a lens model, a lens characteristic, or both of the lens model and the lens characteristic for the image capturing apparatus; performing image processing on the separated foreground and background by applying an optical characteristic obtained by the selected lens model, lens characteristic, or both; and synthesizing the image-processed foreground and background to obtain a final image.

According to an exemplary embodiment of the present invention, a user may arbitrarily adjust optical characteristics of an actual lens, such as a focal length, an F-number, a Bokeh pattern, a resolution, a Vignetting phenomenon without using the actual lens and perform image processing on a captured image based on the adjusted optical characteristic's values, thus representing an object in various ways.

And, According to an exemplary embodiment of the present invention, the characteristics of existing actual lenses may be stored in a database. Thus, upon selecting a specific lens model, a user may receive values matching the characteristics of the lens model and represent a final image based on these values. This process may be also utilized for a realistic rendering scheme using computer graphics.

### BRIEF DESCRIPTION OF THE DRAWINGS

FIG. 1 is a block diagram schematically illustrating a digital image processing apparatus according to an embodiment of the present invention;

FIG. 2 is a view illustrating lens characteristic values selected by a lens selecting unit in a digital image processing apparatus according to an embodiment of the present invention;

FIGS. 3A to 3C are views illustrating exemplary images obtained by the second image obtaining unit depending on selected Vignetting values in a digital image processing apparatus according to an embodiment of the present invention.

### DETAILED DESCRIPTION OF THE PREFERRED EMBODIMENTS

Hereinafter, exemplary embodiments of the present invention will be described in detail with reference to the accompanying drawings and contents to be described below. Therefore, the present invention may be modified in many different forms and it should not be limited to the embodiments set forth herein. Rather, the exemplary embodiments set forth herein are provided to a person of ordinary skilled in the art to thoroughly and completely understand contents disclosed herein and fully provide the spirit of the present invention. Like reference numerals designate like components throughout the specification. Meanwhile, terms used in the present invention are to explain exemplary embodiments rather than limiting the present invention. In the specification, a singular type may also be used as a plural type unless stated specifically. “Comprises” and/or “comprising” used herein does not exclude the existence or addition of one or more other components, steps, operations and/or elements.

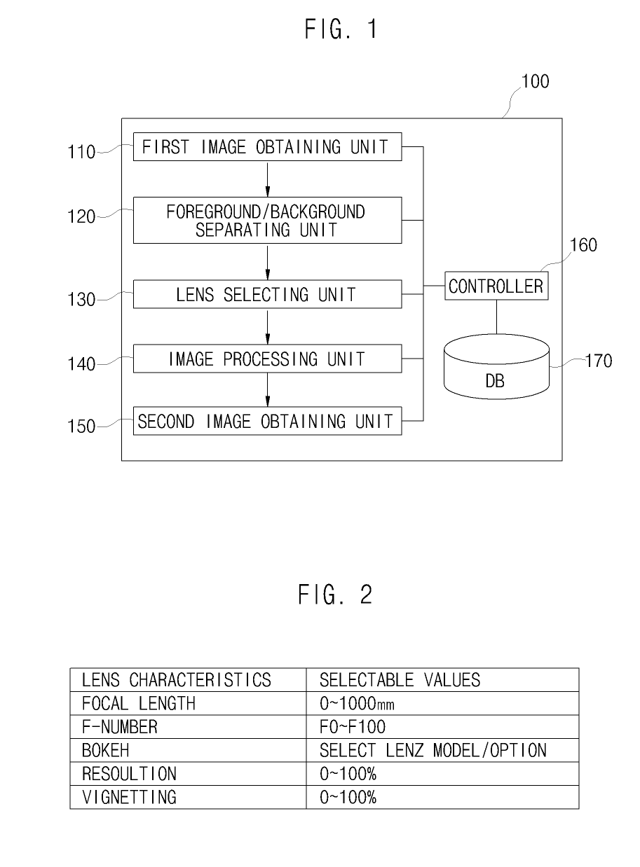

FIG. 1 is a block diagram schematically illustrating a digital image processing apparatus according to an embodiment of the present invention.

Referring to FIG. 1, the digital image processing apparatus 100 includes a first image obtaining unit 110, a foreground/background separating unit 120, a lens selecting unit 130, an image processing unit 140, a second image obtaining unit 150, a controller 160, and a database 170.

The digital image processing apparatus 100 has a similar appearance to that of a digital camera, a digital video camera, or a camera phone. The digital image processing apparatus 100, has elements of a digital imaging apparatus, which include a lens, a shutter, an image pickup device, a display, a flash, and a storage device to capture an image of an object.

The first image obtaining unit 110 may include, a digital camera, a digital camcorder, a camera phone, or any kind of portable terminal having a camera unit. The first image obtaining unit 110 obtains a raw image of an object.

The foreground/background separating unit 120 separates a foreground and a background of the raw image obtained by the first image obtaining unit 110 by using an image subtraction and edge detection scheme. The image subtraction may be referred to as “image deduction” and the foreground may be referred to as the object that is a main target of image capturing. As separating the foreground and the background using the image subtraction and edge detection scheme, the foreground/background separating unit 120 effectively extracts the foreground and the background from the raw image without additional noises.

The image subtraction scheme refers to a frame processing scheme that determines a difference between the foreground image and the background image by removing a specific portion, such as the foreground image or an image of the object, from the raw image. The edge detection scheme refers to a frame processing scheme that detects an edge portion showing a large difference in brightness value by using a gradient filter, a Laplacian filter, a Sobel filter, or a combination thereof.

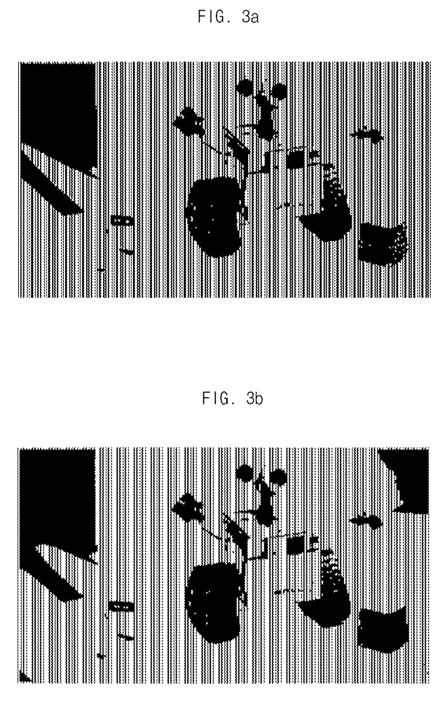

The lens selecting unit 130 selects a lens characteristic, and/or a lens model. The lens selecting unit 130 may include a user interface (refer to ‘200 ’ in FIG. 2) that allows a user to select and adjust a model and a characteristic of a lens. The lens selecting unit 130 may provide information on lens characteristics and lens models stored in the database 170 to the user through the controller 160. For example, the lens selecting unit 130 may display information on models and characteristics of various commercial lenses as already stored through an external display, and output predetermined information in the form of voice or image in response to user's selection signal.

The image processing unit 140 reflects optical properties of a specific lens model or lens characteristic to an image. According to an embodiment, the image processing unit 140 applies lens characteristic values determined by the lens selecting unit 130 to the foreground and the background separated by the foreground/background separating unit 120 for image processing.

According to an embodiment, the image processing unit 140 may adjust a focal length, an F-number, a Bokeh pattern, a resolution, Vignetting, or a combination thereof for the foreground image and/or background image.

When image processing is performed after the foreground and the background are separated from each other, values suitable for the optical properties of the lens may be easily selected to represent a final image.

The second image obtaining unit 150 synthesizes the foreground image and the background image to which the optical properties have been reflected by the image processing unit 140. For example, the second image obtaining unit 150 synthesizes the foreground image and the background image using an image synthesizing scheme, such as, “blending scheme”.

FIG. 2 is a view illustrating lens characteristic values selected by a lens selecting unit in a digital image processing apparatus according to an embodiment of the present invention.

The lens characteristics and selectable values selected by the lens selecting unit of the embodiment may be displayed on the user interface provided by the lens selecting unit as a field for selecting the lens characteristics and a field of displaying the selectable values. According to an embodiment, a user interface 200 shown in FIG. 2 may be used.

Referring to FIG. 2, the user interface 200 includes a field of displaying lens characteristics and a field of displaying selectable values for each lens characteristic.

According to an embodiment, the field of displaying the lens characteristics includes a focal length, an F-number, a Bokeh pattern, a resolution, and Vignetting. The field of displaying the selectable values may have “0 to 1000 mm”, “F0 to F100”, for example, “F1 to F64”, “Select Lens Model” or “(user) Option”, “0 to 100%”, and “0˜100%”, respectively corresponding to sequence disclosed in the field of displaying the lens characteristics. The selectable values corresponding to the lens characteristics may be extracted from the database 170 by the controller 160 of FIG. 1 in response to a selection signal from the user interface 200.

By selecting a specific lens model, a user may obtain characteristics of the lens model without directly entering lens characteristic values. Result images from the second image obtaining unit change according to a focal length and an F-number applied in the image processing Unit 140. For example, the background of a result image obtained by setting high focal length and F-number is more blurred than that of a result image obtained by setting low focal length and F-number.

According to an embodiment, the image processing unit 140 processes image by individually applying a focal length and F-number to each of the foreground image and the background image. So, it may substantially change an obtained region and a depth of the background in the final images. Herein, the “depth of field” refers to the degree of blur of the background.

Result images from the second image obtaining unit may also change according to a Bokeh pattern or lens model. That is, it can be seen that an unfocused portion varies with the Bokeh pattern or lens model pattern selected by a user.

For example, the unfocused portion of a result image is expressed as star shape with star-shaped Bokeh, heart shape with heart shaped Bokeh, and circle shape with circle-shaped Bokeh. And it may be expressed as a different shape according to Lens model pattern.

Result images from the second image obtaining unit may change according to a selection of Resolution values. That is, the foreground of an object in a result image may be more clear or blurred by adjusting the resolution values. Namely, the foreground of an object in a result image with a resolution of 400 may be clearer than with a resolution of 100.

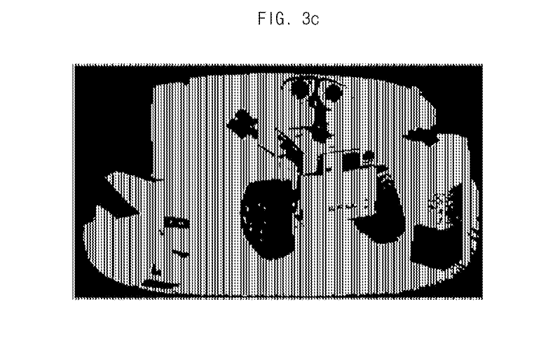

FIGS. 3A to 3C depict exemplary images obtained by the second image obtaining unit depending on selected Vignetting values in a digital image processing apparatus according to an embodiment of the present invention.

It can be seen in FIGS. 3A to 3C that the edge portion of the background image gradually darkens or brightens by adjusting the Vignetting value. The Vignetting value of the image shown in FIG. 3B is higher than that of the image shown in FIG. 3A, so that the edge portion of the image shown in FIG. 3B is darker in many portions than that of the image shown in FIG. 3A. The Vignetting value of the image shown in FIG. 3C is higher than that of the image shown in FIG. 3B, so that the edge portion of the image shown in FIG. 3C is darker in many portions than that of the image shown in FIG. 3B. Herein, the Vignetting values of the images shown in FIGS. 3A, 3B, and 3C may be 0, 50, and 100, respectively.

As described above, the embodiments of the present invention may virtually implement characteristics of various lenses by image processing. Thus, it may provide the same or similar effects as those obtainable by actual lenses to an imaging apparatus whose lens is impossible to exchange, and without exchange with another type of lens or lens of another manufacturer.

An exemplary embodiment of the present invention is disclosed through a detailed description and drawings as described above. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An image processing apparatus comprising:
a first image obtaining unit that obtains a raw image through an image capturing apparatus;
a foreground/background separation unit that separates a foreground and a background from the raw image obtained by the first image obtaining unit;
a lens selecting unit that selects a lens model, a lens characteristic, or a combination thereof;
an image processing unit that performs image processing on the foreground and the background by respectively applying a predetermined calibration value for the lens model, the lens characteristic, or the combination thereof; and
a second image obtaining unit that synthesizes the image-processed foreground and background to obtain a processed image.

2. The image processing apparatus according to claim 1, wherein the first image obtaining unit, the foreground/background separation unit, the lens selecting unit, the image processing unit, and the second image obtaining unit are applied to computer graphics rendering.

3. The image processing apparatus according to claim 1, wherein the lens selecting unit has a user interface through which a selection signal for the lens model, the lens characteristic, or the combination thereof is received.

4. The image processing apparatus according to claim 1, wherein the lens characteristic includes a focal length, an F-number, a Bokeh pattern, a resolution, Vignetting, or a combination thereof.

5. The image processing apparatus according to claim 1, further comprising:
a database that stores information on the lens model, the lens characteristic, or the combination thereof.

6. The image processing apparatus according to claim 1, wherein the foreground/background separating unit extracts the foreground from the raw image using an image subtraction and edge detection scheme.

7. The image processing apparatus according to claim 6, wherein the edge detection scheme is performed by detecting an edge portion showing a large difference in brightness value using a gradient filter, a Laplacian filter, a Sobel filter, or a combination thereof.

8. An image processing method for virtually representing an image varying with lens characteristics through an image processing scheme, comprising:
analyzing a raw image captured by an image capturing apparatus to separate a foreground and a background from the raw image;
selecting a lens model, a lens characteristic, or both of the lens model and the lens characteristic for the image capturing apparatus;
performing image processing on the separated foreground and background by applying an optical characteristic obtained by the selected lens model, lens characteristic, or both; and
synthesizing the image-processed foreground and background to obtain a final image.

9. The image processing method according to claim 8, wherein the analyzing, the selecting, the performing, and the synthesizing are applied to computer graphics rendering.

10. The image processing method according to claim 8, wherein the optical characteristic includes a focal length, an F-number, a Bokeh pattern, a resolution, Vignetting, or a combination thereof.

11. The image processing method according to claim 8, wherein the separating the foreground and the background includes extracting the foreground from the raw image using an image subtraction and edge detection scheme.
